(19) United States
(12) Patent Application Publication
(10) Pub. No.: US 2012/0257279 A1
(43) Pub. Date: Oct. 11, 2012

(54) GRATING BASED TUNABLE FILTER

(76) Inventor: Yung-Chieh Hsieh, San Jose, CA (US)

(21) Appl. No.: 13/441,899

(22) Filed: Apr. 8, 2012

Related U.S. Application Data
(60) Provisional application No. 61/473,079, filed on Apr. 7, 2011.

(51) Int. Cl. G02B 5/18

(52) U.S. Cl. 359/572

(57) ABSTRACT

In a grating based tunable filter, an input beam that includes multiple wavelengths is directed into an input fiber of a circulator. The beam is collimated and then is reflected by a rotationally actuated mirror. The beam is then magnified and propagates onto and through a transmission diffraction grating which causes the different wavelengths of the transmitted beam to deflect into different angles. The wavelengths propagate onto and are reflected by a mirror and only a small portion of the wavelength spectrum of the transmitted beam will be reflected back along the incoming path and then propagate to the output fiber

### CROSS-REFERENCE TO RELATED APPLICATIONS

This application claims the benefit of U.S. Provisional Patent Application No. 61/473,079 titled “Grating Based Tunable Filter,” filed Apr. 7, 2011, incorporated herein by reference.

### BACKGROUND OF THE INVENTION

1. Field of the Invention

The present invention relates to reconfigurable optical networks and spectrometer scanning engines, and more specifically, it relates to tunable filters for use in such networks and engines.

2. Description of Related Art

Several types tunable optical filters are known in the art. Some commonly used filters include rotating or tilting thin-film bandpass optical filters, linearly-variable thin-film filters, electrically, thermally, or acoustically controlled tunable wavelength etalons and thermally-sensitive cavity layers located between the reflective layers of a thin-film filter structure.

U.S. Pat. No. 7,899,330, titled “Compact high-resolution tunable optical filter using optical diffraction element and a mirror” overcomes some of the drawbacks of the prior art. The patent uses at least one diffraction element to diffract light of multiple wavelengths into different wavelength components. Instead of moving the diffraction element as in certain prior filters, light from the at least one element is reflected, with an adjustable MEMS mirror, back towards the at least one element so that light is diffracted at least twice by the at least one element. The reflection is such that at least one selected wavelength component of said wavelength components will pass from an input port to an output port or to another device. The patent teaches that the use of a single optical transmission grating typically provides a very low dispersion effect. This makes it hard to separate the closely spaced wavelength channels that are used in DWDM systems with 100 GHz or 50 GHz channel spacings. It further teaches that although gratings with larger dispersion power exist, they are usually significantly more expensive and are further complicated by the need to add special prisms. The inventors' intended to overcome this limitation by using two cascaded optical transmission gratings, as well as a high resolution reflective MEMS mirror to pass the signal four times through a grating (by passing twice through each of two gratings). This significantly increases the total dispersion angle achieved, and thus results in a high degree of adjacent channel isolation.

### SUMMARY OF THE INVENTION

It is an object of the present invention to provide a tunable optical filter hat overcomes the above described problems. In the present invention, a MEMS mirror is used in the input path. Therefore, the required rotation angle of the mirror is only one half of the case where the mirror is placed behind the grating. This makes the MEMS mirror and the tunable optical filter system much easier to manufacture compared to the prior art. In the present invention, placement of a beam expander in front of the grating enables the use a collimator with short focal length and still achieves a large beam size on the grating to maintain good spectrum resolution. Shorter focal length collimators makes the alignment much more stable. With both the MEMs mirror and the telescope placed before the grating, one can use a focusing lens followed by a bandwidth selector to produce a flat-top tunable filter.

In an exemplary embodiment of the present invention, an input beam that includes multiple wavelengths is directed into an input fiber of a circulator. The beam is collimated and then is reflected by a rotationally actuated mirror, e.g., a MEMS mirror. The beam is then magnified and propagates onto and through a transmission diffraction grating which causes the different wavelengths of the transmitted beam to deflect into different angles. The wavelengths propagate onto and are reflected by a mirror and only a small portion of the wavelength spectrum of the transmitted beam will be reflected back along the incoming path and then propagate to the output fiber.

In another embodiment, the grating is a reflecting grating and is used to return the output beam to the output fiber. Embodiments are described that use dual fiber collimators, and each collimator directs its output to a separate dedicated rotationally actuated mirror. Another exemplary embodiment provides a lens after the grating. The lens is configured to direct the deflected wavelengths onto a focal plane, on which is a bandwidth selector sized to reflect a predefined bandwidth. Another embodiment utilizes the magnification optics to direct the deflected wavelengths onto the focal plane. Still another embodiment corrects for shifts in the return beam by inserting an optical wedge in the beam. Another embodiment corrects beam shifts by utilizing an adjustable mirror that is adjustable in two-dimensions.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows a schematic diagram of an embodiment of the invention utilizing a transmission grating and reflector on a rotational actuator.

FIG. 2 shows a design that uses a reflection grating.

FIG. 3 is a schematic diagram showing an array of two tunable filters in one module.

FIG. 4 is a schematic diagram of a tunable filter design with bandwidth adjustment capability.

FIG. 5 shows another design that uses one lens to expand the beam before the grating and to focus the diffracted beams to the plane of a bandwidth selector.

FIG. 6 is a schematic of transmission grating based tunable filter with an optical plane plate with a small wedge.

### DETAILED DESCRIPTION OF THE INVENTION

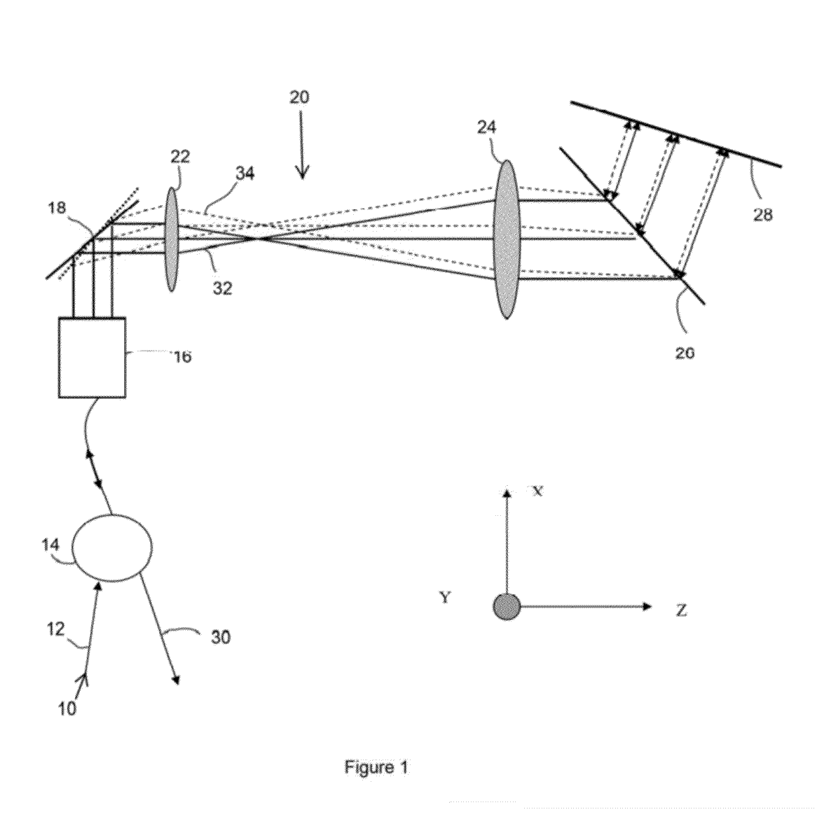

FIG. 1 shows a schematic diagram of an embodiment of the invention. An input beam 10 comprising a spectrum of wavelengths is directed into input fiber 12 of circulator 14. The beam is collimated by input/output collimator 16. The collimated beam impinges onto a mirror 18 that is mounted on a rotation actuator. Such actuators are known in the art. To achieve high spectral resolution, one needs to expand the beam to a greater diameter to cover more lines on a grating. Thus, after beam 10 is reflected by mirror 18, it is magnified by beam expander 20, which comprises magnification optics 22 and 24, which are both positive lenses in this case. Beam 10 then propagates onto and through transmission diffraction grating 26. The different wavelengths of the transmitted beam deflect into different angles by the diffraction grating. The wavelengths propagate onto and are reflected by mirror 28. Only a small portion of the wavelength spectrum of the transmitted beam will be perpendicular to the reflection mirror such that it will be reflected back along the incoming path and then propagate to an output fiber 30.

The rotation actuator can rotate along the Y-axis, which is perpendicular to the plane of the page, to change the angle of the mirror. As a result, the incident angle to the diffraction grating is changed. In FIG. 1, the solid traces 32 and dashed traces 34 correspond to the beams in two incident angles to the grating, respectively. For each angle of the actuator, only the beam of a small portion of the wavelength spectrum is perpendicular to the reflection mirror. This beam with the desired wavelength is reflected back along the incoming path and then goes to the output fiber. This achieves the function of a tunable filter.

For simplicity, in FIG. 1, the output light is directed to the output fiber through a circulator. Other designs are useable. For example, one can use a dual-fiber collimator, with the two fibers separated along the Y-direction, to send the input light through one fiber and collect the output light at the other fiber. A dual-fiber collimator is composed of two fibers side-by-side and a lens. The tips of the fibers are placed near the focal plane of the lens. The dual-fiber collimator is aligned such that the line connecting the center of one fiber tip to the center of the other fiber tip of the collimator is perpendicular to the incident plane of the actuator mirror.

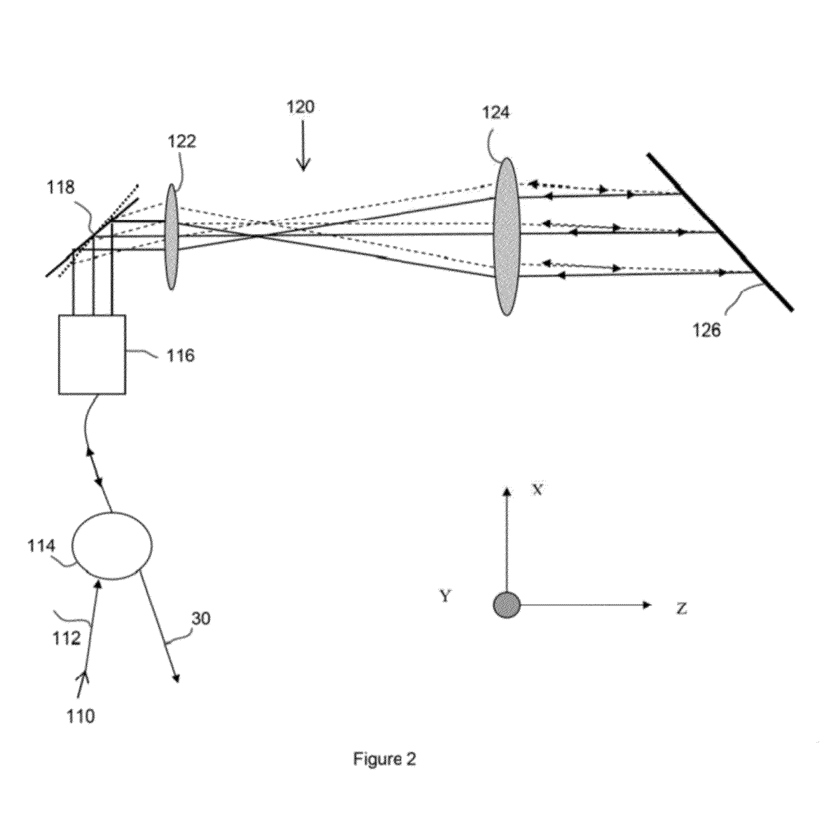

FIG. 2 shows a design that uses a reflection grating. An input beam 100 comprising a spectrum of wavelengths is directed into input fiber 112 of circulator 114. The beam is collimated by input/output collimator 116. The collimated beam impinges onto a mirror 118 that is mounted on a rotation actuator. After beam 110 is reflected by mirror 118, it is magnified by beam expander 120, which comprises magnification optics 122 and 124, which are both positive lenses in this case. Beam 110 then propagates onto and is reflected by reflecting diffraction grating 126. Only a small portion of the wavelength spectrum of the reflected beam will be reflected back along the incoming path and then propagate to output fiber 130.

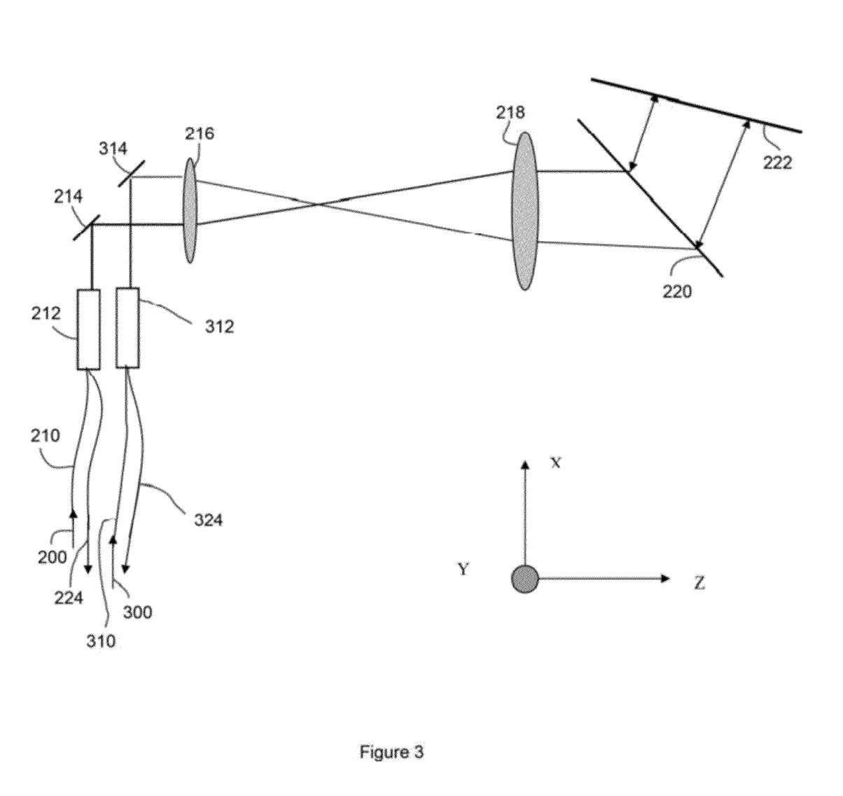

FIG. 3 is a schematic diagram showing an array of two tunable filters in one module. In this figure, only the chief ray of each tunable filter is plotted. It uses two mirror-actuator assemblies, two dual-fiber collimators, one beam expander, one grating, and one reflection mirror in one package. Thus, it has the advantage of cost reduction, in material and labor, and achieves a compact footprint. Specifically, input beam 200 is directed into input fiber 210 which is connected to input/output collimator 212. Beam 200 is reflected from a rotation actuated mirror 214 through magnification optics 216 and 218, through transmission grating 220 and onto mirror 222. As in the previous embodiments, the angle of the rotation actuated mirror determines the wavelength that will be reflected back to output fiber 224. In like manner, input beam 300 is directed into input fiber 310 which is connected to input/output collimator 312. Beam 300 is reflected from a rotation actuated mirror 314 through magnification optics 216 and 218, through transmission grating 220 and onto mirror 222. As in the previous embodiments, the angle of the rotation actuated mirror determines the wavelength that will be reflected back to output fiber 324. This design can be modified by replacing the transmission grating with a reflecting diffraction grating 126 as in the embodiment of FIG. 2.

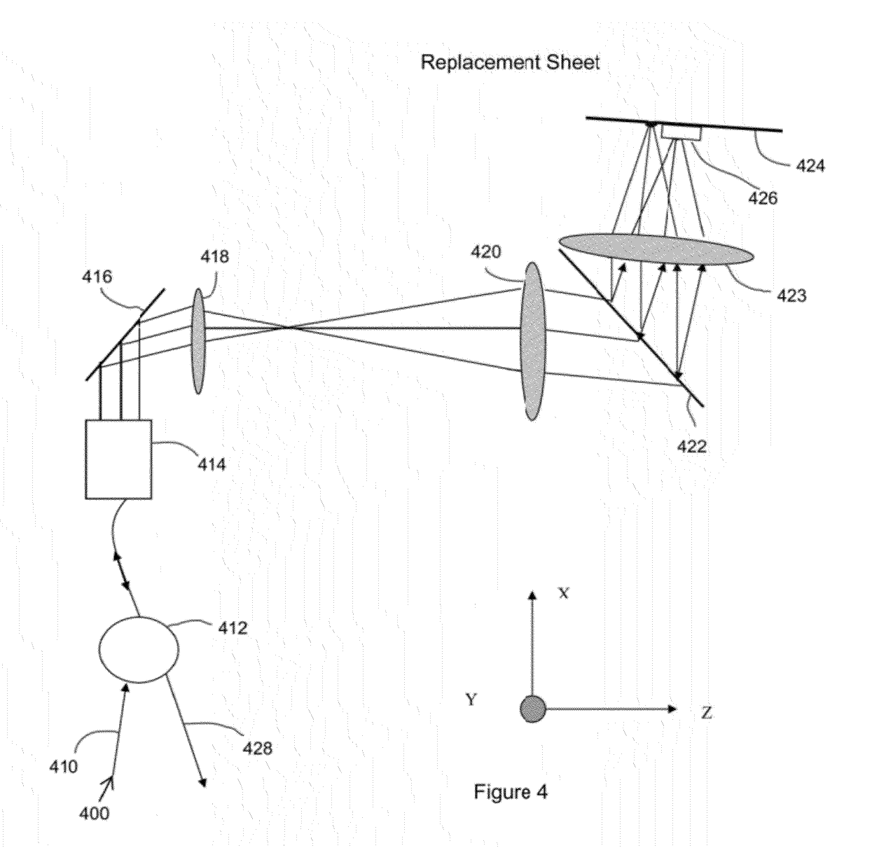

FIG. 4 is a schematic diagram of a tunable filter design with bandwidth adjustment capability. In this design, a focusing lens is placed after the grating to focus the diffracted light to a focal plane. Each wavelength has its own focus spot on the focal plan. On the focal plane, a bandwidth selector is used, instead of a simple reflection mirror. The bandwidth selector is designed to reflect only the light near the optical axis. For instance, the bandwidth selector can be a highly reflective circular disk surrounded by a non-reflective area. The bandwidth of the filter is proportional to the diameter of the reflective circular disk. By varying the diameter of the reflective disk, one can change the bandwidth of the filter. For simplicity, in FIG. 4, two wavelengths are plotted after the grating. The beam that hits the center of the reflector is reflected back to the grating. It will be collected by the receiving fiber. In contrast, the beam that is focused away from the reflector will miss the receiving fiber, and be rejected. More specifically, an input beam 400 is directed into input fiber 410 which directed light through circulator 412 after which it is collimated by input/output collimator 414. The collimated beam is reflected by the rotationally actuated mirror 416, expanded by optics 418 and 420 and directed through diffraction grating 422. The diffracted light is collected and focused onto focal plane 424. A bandwidth selector 426 is located at the focal plane. The remainder of the focal plane is non-reflective. Only the portion of the beam that is reflected by the bandwidth selector can reach the output fiber 428.

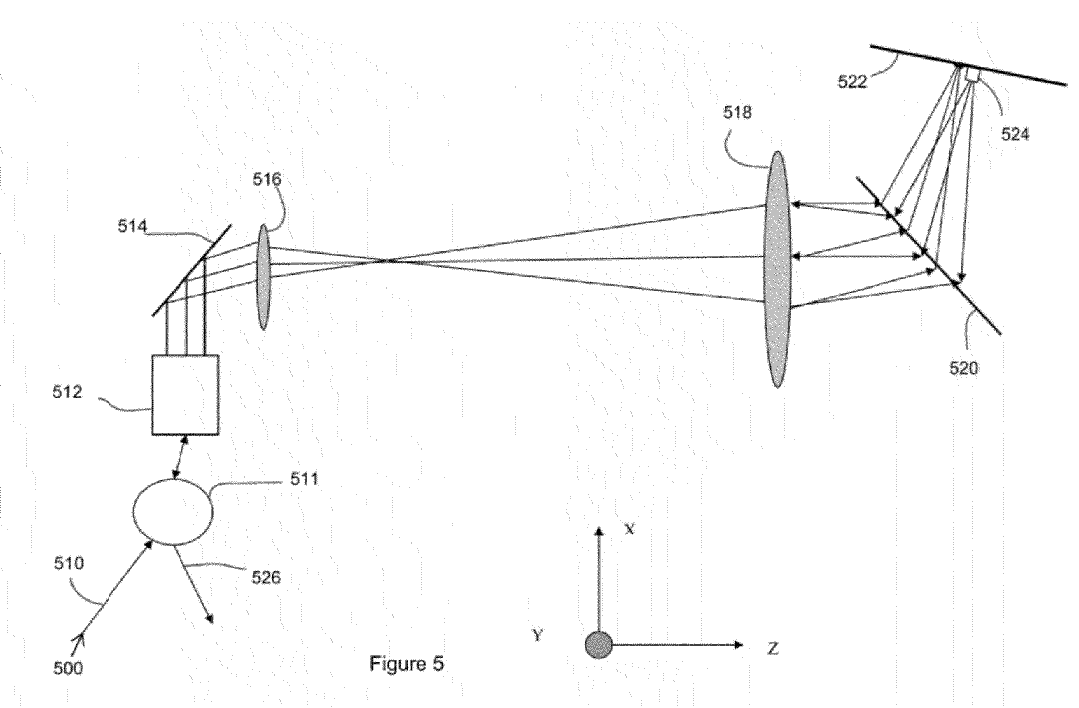

FIG. 5 shows another design similar to FIG. 4. It uses one lens to provide a large convergent beam before the grating and focus the diffracted beams to the plane of a bandwidth selector. In FIG. 4, there are two lenses, each located before and after the diffraction grating. In this case, the grating is in a collimated space.

An input beam 500 is directed into input fiber 510 of circulator 511, the light from which is collimated by input/output collimator 512 and then reflected by rotationally actuated mirror 514. The reflected beam is focused by optics 516 at its focal plan, which is an intermediate image plane of the source at the tip of the input port fiber, and then this focal point is imaged by optics 518 on an image plane 522. The image on the intermediate image plane can be either a real or virtual image of the source, depending on the type of beam expander that is sued. If both lenses of the beam expander are positive, the intermediate image of the source is real. If one positive and one negative (as in a Galilean telescope), then the intermediate image is virtual. These optics are selected so that the expanded beam will focus at different points on the image plane for different wavelength components. The large convergent beam after optics 518 passes through diffraction grating 520 and each wavelength is focused at the image plane. A bandwidth selector 524 is located at the focal plane. Only the light reflected by the bandwidth selector can be reflected to the output fiber 526.

To minimize polarization dependent loss, in FIGS. 1 and 3, one can insert a ¼ wave plate between the reflection mirror and the grating. In FIGS. 4 and 5, the ¼ wave plate can be inserted right after the grating.

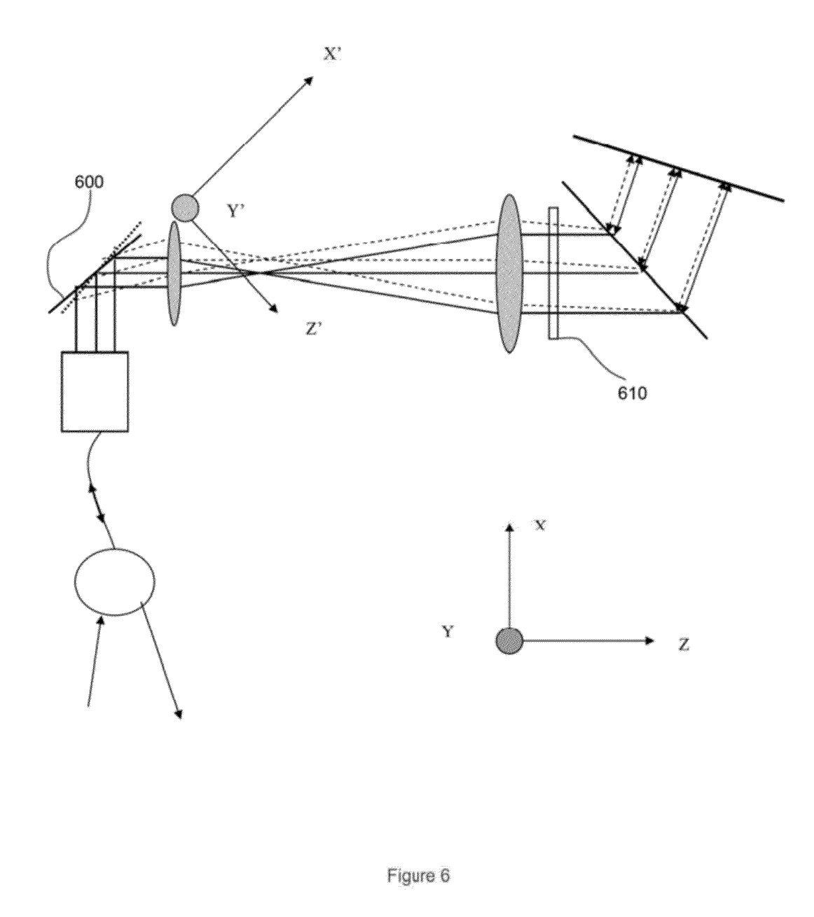

FIG. 6 is identical to FIG. 1 except that it includes a two-dimensionally adjustable MEMS mirror 600 and/or and optical plate 610. The MEMS mirror used in FIG. 1 can be tilted about one axis (Y-axis), and hence is called a 1-D MEMS mirror. This rotation axis of the 1-D MEMS mirror is aligned to be parallel to the grating groove lines.

During operation of the device, the returned beam could deviate from the incoming path. If the deviation at the receiving fiber is in the direction perpendicular to the grating groove lines, the output wavelength will be changed. This can be corrected easily by tilting the MEMS mirror. When the deviation is in the direction parallel to the grating groove lines, the insertion loss becomes greater. Optical plane plate 610 with a very small wedge can be inserted into the collimated space, such as the space before the first magnification lens or after the magnification lens, as shown in FIG. 6, to correct the misalignment during the assembly. This can effectively improve the yield of the filter.

A 2-D MEMS mirror 600 having two rotational axes, e.g., the two axes (Y′- and X′-axis) in FIG. 6, can used to change the direction of the beam. The rotational actuator has a first axis (Y′-axis) to change the beam direction in the direction perpendicular to the grating groove lines, and hence change the angle of incidence to the grating and the wavelength.

When the mirror is rotated about the second axis (X′-axis) of the 2-D MEMS mirror, the reflected beam is defected along the direction parallel to the grating groove lines. Because the beam deflects in the direction along the grating groove lines, this movement causes the returned beam to deviate from the receiving fiber (output port). As a result, the insertion loss changes, but the wavelength is not affected. Therefore, this second axis provides a function to change the transmittance of the filter (i.e., insertion loss). The rotation about the second axis can be used to correct the insertion loss if the module becomes misaligned.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A tunable optical filter, comprising:
an input port for receiving input light of multiple wavelengths;
a first adjustable mirror positioned to reflect said input light to produce reflected light;
a diffraction grating positioned to diffract said reflected light into different wavelength components to produce diffracted light;
means for directing said diffracted light back towards said first adjustable mirror; and
means for adjusting the direction of said first adjustable mirror so that a selected wavelength of the different wavelength components will propagate to an output port.

2. The tunable optical filter of claim 1, further comprising a collimator positioned between said input port and said first adjustable mirror and configured to collimate said input light before said input light is reflected by said first adjustable mirror.

3. The tunable optical filter of claim 1, further comprising a beam expander operably located between said first adjustable mirror and said grating to expand said reflected light before it propagates onto said grating.

4. The tunable optical filter of claim 1, wherein said grating comprises a transmission grating.

5. The tunable optical filter of claim 4, wherein said means for directing comprises a reflector positioned to receive and reflect said diffracted light back towards said first adjustable mirror.

6. The tunable optical filter of claim 1, wherein said first adjustable mirror comprises a micro-electromechanical systems (MEMS) mirror.

7. The tunable optical filter of claim 6, wherein said means for adjusting comprises means for applying a voltage to said MEMS mirror.

8. The tunable optical filter of claim 1, wherein said means for adjusting comprises a rotational actuator attached to said first mirror.

9. The tunable optical filter of claim 1, further comprising a fiber optic circulator, wherein said input port is an input fiber of said fiber optic circulator and wherein said output port is an output fiber of said fiber optic circulator.

10. The tunable optical filter of claim 1, wherein said diffraction grating comprises a reflecting grating operably fixed such that it functions as said means for directing.

11. The tunable optical filter of claim 1, further comprising:
a second input port for receiving second input light of multiple wavelengths;
a second adjustable mirror positioned to reflect said second input light to produce second reflected light;
wherein said diffraction grating is positioned to diffract said second reflected light into different wavelength components to produce second diffracted light;
wherein said means for directing said diffracted light back towards said first adjustable mirror is configured to direct said second diffracted light back towards said second adjustable mirror; and
means for adjusting the direction of said second adjustable mirror so that a selected wavelength of the different wavelength components will propagate to a second output port.

12. The tunable optical filter of claim 1, wherein said grating comprises a transmission grating, wherein said filter further comprises a lens positioned to focus said diffracted light onto a focal plane, wherein said means for directing comprises a reflector positioned at said focal plane.

13. The tunable optical filter of claim 12, wherein said reflector comprises a dimension that determines the bandwidth of said diffracted light that will be directed back towards said first mirror.

14. The tunable optical filter of claim 3, wherein said grating comprises a transmission grating, wherein said beam expander comprises a first lens and a second lens, wherein a first image, real or virtual, between said first lens and said second lens is relayed by said second lens to an image plane, wherein said means for directing comprises a reflector positioned at said image plane.

15. The tunable optical filter of claim 14, wherein said reflector comprises a dimension that determines the bandwidth of said diffracted light that will be directed back towards said first mirror.

16. The tunable optical filter of claim 6, further comprising means for adjusting said MEMs in two dimensions.

17. The tunable optical filter of claim 1, further comprising a ¼ wave plate inserted between said grating and said reflector, wherein said wave plate minimizes polarization dependent loses.

18. The tunable optical filter of claim 1, further comprising an optical plane plate with a wedge operably located in said filter to correct misalignment.

19. A method, comprising:
receiving input light of multiple wavelengths into an input port;
reflecting said input light with a first mirror to produce reflected light;
diffracting, with a diffraction grating, said reflected light into different wavelength components to produce diffracted light;
directing said diffracted light back towards said first mirror; and
adjusting the direction of said first mirror so that a selected wavelength of the different wavelength components will propagate to an output port.

20. The method of claim 19, further comprising collimating said input light before said input light is reflected by said first mirror.

21. The method of claim 19, further comprising expanding said reflected light before it propagates onto said grating.

22. The method of claim 19, wherein said grating comprises a transmission grating.

23. The method of claim 22, wherein the step of directing comprises positioning a second mirror to receive and reflect said diffracted light back towards said first mirror.

24. The method of claim 19, wherein said first mirror comprises a MEMS mirror.

25. The method of claim 19, wherein the step of adjusting comprises applying a voltage to said MEMS mirror.

26. The method of claim 19, wherein the step for adjusting comprises rotating a rotational actuator attached to said first mirror.

27. The method of claim 19, wherein said diffraction grating comprises a reflecting grating operably fixed such that it functions to carry out the step of directing.

28. The method of claim 19, further comprising:
receiving second input light of multiple wavelengths into a second input port;
reflecting said second input light with a second adjustable mirror to produce second reflected light,
diffract said second reflected light into different wavelength components to produce second diffracted light;
directing said second diffracted light back towards said second adjustable mirror; and
adjusting the direction of said second adjustable mirror so that a selected wavelength of the different wavelength components will propagate to a second output port.

29. The method of claim 19, wherein said grating comprises a transmission grating, the method further comprising focusing said diffracted light onto a focal plane, wherein the step of directing is carried out with a reflector positioned at said focal plane.

30. The method of claim 29, wherein said reflector comprises a dimension that determines the bandwidth of said diffracted light that will be directed back towards said first mirror.

31. The method of claim 21, wherein said grating comprises a transmission grating, wherein the step of expanding is carried out with a beam expander comprising a first lens and a second lens, wherein a first image, real or virtual, between said first lens and said second lens is relayed by said second lens to an image plane, wherein said means for directing comprises a reflector positioned at said image plane.

32. The method of claim 31, wherein said reflector comprises a dimension that determines the bandwidth of said diffracted light that will be directed back towards said first mirror.

33. The method of claim 24, further comprising adjusting said MEMs in two dimensions.

34. The method of claim 19, further comprising minimizing polarization dependent loses by operably positioning a ¼ wave plate between said grating and said reflector.

35. The method of claim 19, further comprising correcting misalignments by operably locating in said filter an optical plane plate with a wedge.
